(19) United States
(12) Patent Application Publication
(10) Pub. No.: US 2024/0185031 A1
(43) Pub. Date: Jun. 6, 2024

(54) SERVER, ELECTRONIC APPARATUS FOR ENHANCING SECURITY OF NEURAL NETWORK MODEL AND TRAINING DATA AND CONTROL METHOD THEREOF

(71) Applicant: CRYPTO LAB INC., Seoul (KR)

(72) Inventors: Seewoo Lee, Chungju-si (KR); Jung Woo Kim, Seoul (KR); Junbum Shin, Suwon-si (KR)

(21) Appl. No.: 18/501,811

(22) Filed: Nov. 3, 2023

(30) Foreign Application Priority Data
Nov. 7, 2022 (KR) 10-2022-0147375
Jul. 7, 2023 (KR) 10-2023-0088540

(51) Int. Cl. G06N 3/045; H04L 9/00

(52) U.S. Cl. CPC G06N 3/045; H04L 9/008

(57) ABSTRACT

A server is disclosed. The server includes a communication interface, a memory configured to store at least one instruction, and a processor configured to be connected with the communication interface and the memory, and control the server, wherein the processor is configured to, by executing the at least one instruction, receive, through the communication interface, a homomorphic encryption wherein training data is homomorphically encrypted from an electronic apparatus, train a first neural network model stored in the memory based on the homomorphic encryption and acquire a second neural network model, perform an addition operation of a random value to the second neural network model and acquire a third neural network model, control the communication interface to transmit the third neural network model to the electronic apparatus, receive, through the communication interface, a fourth neural network model which is decrypted from the third neural network model from the electronic apparatus, and perform a subtraction operation of the random value to the fourth neural network model and acquire a final neural network model.

### CROSS-REFERENCE TO RELATED APPLICATIONS

The present application claims priority to Korean Patent Application No. 10-2022-0147375 filed on Nov. 7, 2022, and Korean Patent Application No. 10-2023-0088540 filed on Jul. 7, 2023, the disclosures of all of which are incorporated herein by reference in their entirety.

### BACKGROUND OF THE INVENTION

### 1. Field of the Invention

The disclosure relates to a server, an electronic apparatus, and control methods thereof, and more particularly, to a server and an electronic apparatus for enhancing security of a neural network model and training data, and control methods thereof.

### 2. Description of the Related Art

As deep learning has been developed recently, transfer learning is being used for making a deep neural network model with high performance. The most representative example of transfer learning is a method of fine-tuning only parameters of a classification layer in a model that was pre-trained with a large amount of data. Such a method can make training completed much more faster than randomly initializing the entire parameters of a model, and then training the model from the start.

However, in a process of training a model through transfer learning, if training data is provided to a server, there is a risk that personal information related to the training data may be infringed. For this, a model may be trained while protecting training data by using a multi party computation, but a multi party computation has a disadvantage that time spent for communication increases.

Alternatively, a neural network model may be provided to a client, and the client may train the neural network model by using training data, but there is a problem that the parameters of the neural network model are exposed to the client. There is also the same problem in the case of federated learning (FL) wherein such a method is extended to a plurality of clients.

### SUMMARY OF THE INVENTION

The disclosure is for addressing the aforementioned need, and the purpose of the disclosure is in providing a server and an electronic apparatus for training a neural network model based on training data while maintaining security of the neural network model and the training data, and control methods thereof.

According to one or more embodiments of the disclosure for achieving the aforementioned purpose, a server includes a communication interface, a memory configured to store at least one instruction, and a processor configured to be connected with the communication interface and the memory, and control the server, wherein the processor is configured to, by executing the at least one instruction, receive, through the communication interface, a homomorphic encryption wherein training data is homomorphically encrypted from an electronic apparatus, train a first neural network model stored in the memory based on the homomorphic encryption and acquire a second neural network model, perform an addition operation of a random value to the second neural network model and acquire a third neural network model, control the communication interface to transmit the third neural network model to the electronic apparatus, receive, through the communication interface, a fourth neural network model which is decrypted from the third neural network model from the electronic apparatus, and perform a subtraction operation of the random value to the fourth neural network model and acquire a final neural network model.

Also, the processor may perform an addition operation of a plurality of random values to each of a plurality of weights included in the second neural network model and acquire the third neural network model, and perform a subtraction operation of the plurality of random values to each of a plurality of weights included in the fourth neural network model and acquire the final neural network model.

In addition, the final neural network model may be a neural network model trained from the first neural network model based on the training data.

Further, the processor may receive, through the communication interface, a plurality of homomorphic encryptions from each of a plurality of electronic apparatuses, train the first neural network model based on each of the plurality of homomorphic encryptions and acquire a plurality of second neural network models, perform an addition operation of the random value to each of the plurality of second neural network models and acquire a plurality of third neural network models, control the communication interface to transmit each of the plurality of third neural network models to the plurality of electronic apparatuses, receive, through the communication interface, the plurality of fourth neural network models decrypted from each of the plurality of third neural network models from each of the plurality of electronic apparatuses, perform a subtraction operation of the random value to each of the plurality of fourth neural network models and acquire a plurality of fifth neural network models, and perform weighted averaging of the plurality of fifth neural network models and acquire a final neural network model.

Also, the processor may receive, through the communication interface, information on the number of training data of each of the plurality of electronic apparatuses from the plurality of electronic apparatuses, and perform weighted averaging of the plurality of fifth neural network models based on the received information.

In addition, the processor may receive, through the communication interface, an operation key and the homomorphic encryption wherein the training data is homomorphically encrypted with an encryption key corresponding to the operation key from the electronic apparatus, train the first neural network model based on the homomorphic encryption and the operation key and acquire the second neural network model, perform an addition operation of the random value to the second neural network model and acquire the third neural network model, control the communication interface to transmit the third neural network model to the electronic apparatus, receive, through the communication interface, the fourth neural network model decrypted from the third neural network model based on a decryption key corresponding to the operation key from the electronic apparatus, and perform a subtraction operation of the random value to the fourth neural network model and acquire the final neural network model.

Meanwhile, according to one or more embodiments of the disclosure, an electronic apparatus includes a communication interface, a memory configured to store at least one instruction, and a processor configured to be connected with the communication interface and the memory, and control the electronic apparatus, wherein the processor is configured to, by executing the at least one instruction, homomorphically encrypt training data stored in the memory and acquire a homomorphic encryption, control the communication interface to transmit the homomorphic encryption to a server, receive, through the communication interface, a neural network model wherein an addition operation of a random value was performed to a neural network model trained based on the homomorphic encryption from the server, decrypt the neural network model wherein an addition operation of the random value was performed, and control the communication interface to transmit the decrypted neural network model to the server.

Also, the processor may acquire an encryption key, a decryption key, and an operation key based on a homomorphic encryption algorithm, and homomorphically encrypt the training data based on the encryption key and acquire the homomorphic encryption, control the communication interface to transmit the homomorphic encryption and the operation key to the server, receive, through the communication interface, a neural network model wherein an addition operation of the random value was performed to a neural network model trained based on the homomorphic encryption and the operation key from the server, decrypt the neural network model wherein an addition operation of the random value was performed based on the decryption key, and control the communication interface to transmit the decrypted neural network model to the server.

Meanwhile, according to one or more embodiments of the disclosure, a control method of a server includes the steps of receiving a homomorphic encryption wherein training data is homomorphically encrypted from an electronic apparatus, training a first neural network model based on the homomorphic encryption and acquiring a second neural network model, performing an addition operation of a random value to the second neural network model and acquiring a third neural network model, transmitting the third neural network model to the electronic apparatus, receiving a fourth neural network model which is decrypted from the third neural network model from the electronic apparatus, and performing a subtraction operation of the random value to the fourth neural network model and acquiring a final neural network model.

Also, in the step of acquiring the third neural network model, an addition operation of a plurality of random values may be performed to each of a plurality of weights included in the second neural network model and the third neural network model may be acquired, and in the step of acquiring the final neural network model, a subtraction operation of the plurality of random values may be performed to each of a plurality of weights included in the fourth neural network model and the final neural network model may be acquired.

In addition, the final neural network model may be a neural network model trained from the first neural network model based on the training data.

Also, in the step of receiving the homomorphic encryption, a plurality of homomorphic encryptions may be received from each of a plurality of electronic apparatuses, and in the step of acquiring the second neural network model, the first neural network model may be trained based on each of the plurality of homomorphic encryptions and a plurality of second neural network models may be acquired, and in the step of acquiring the third neural network model, an addition operation of the random value may be performed to each of the plurality of second neural network models and a plurality of third neural network models may be acquired, and in the step of transmitting, each of the plurality of third neural network models may be transmitted to the plurality of electronic apparatuses, and in the step of receiving the fourth neural network model, the plurality of fourth neural network models decrypted from each of the plurality of third neural network models may be received from each of the plurality of electronic apparatuses, and in the step of acquiring the final neural network model, a subtraction operation of the random value may be performed to each of the plurality of fourth neural network models and a plurality of fifth neural network models may be acquired, and weighted averaging of the plurality of fifth neural network models may be performed and a final neural network model may be acquired.

In addition, the control method may further include the step of receiving information on the number of training data of each of the plurality of electronic apparatuses from the plurality of electronic apparatuses, and in the step of acquiring the final neural network model, weighted averaging of the plurality of fifth neural network models may be performed based on the received information.

Further, in the step of receiving the homomorphic encryption, an operation key and the homomorphic encryption wherein the training data is homomorphically encrypted with an encryption key corresponding to the operation key may be received from the electronic apparatus, and in the step of acquiring the second neural network model, the first neural network model may be trained based on the homomorphic encryption and the operation key and the second neural network model may be acquired, and in the step of acquiring the third neural network model, an addition operation of the random value may be performed to the second neural network model and the third neural network model may be acquired, and in the step of transmitting, the third neural network model may be transmitted to the electronic apparatus, and in the step of receiving the fourth neural network model, the fourth neural network model decrypted from the third neural network model based on a decryption key corresponding to the operation key may be received from the electronic apparatus, and in the step of acquiring the final neural network model, a subtraction operation of the random value may be performed to the fourth neural network model and the final neural network model may be acquired.

Meanwhile, according to one or more embodiments of the disclosure, a control method of an electronic apparatus includes the steps of homomorphically encrypting training data and acquiring a homomorphic encryption, transmitting the homomorphic encryption to a server, receiving a neural network model wherein an addition operation of a random value was performed to a neural network model trained based on the homomorphic encryption from the server, decrypting the neural network model wherein an addition operation of the random value was performed, and transmitting the decrypted neural network model to the server.

Also, in the acquiring step, an encryption key, a decryption key, and an operation key may be acquired based on a homomorphic encryption algorithm, and the training data may be homomorphically encrypted based on the encryption key and the homomorphic encryption may be acquired, and in the step of transmitting the homomorphic encryption, the homomorphic encryption and the operation key may be transmitted to the server, and in the step of receiving, a neural network model wherein an addition operation of the random value was performed to a neural network model trained based on the homomorphic encryption and the operation key may be received from the server, and in the step of decrypting, the neural network model wherein an addition operation of the random value was performed may be decrypted based on the decryption key, and in the step of transmitting the decrypted neural network model, the decrypted neural network model may be transmitted to the server.

According to the various embodiments of the disclosure as above, a server or an electronic apparatus provides data by using a homomorphic encryption, and thus personal information can be protected in a transfer learning or federated learning process.

### BRIEF DESCRIPTION OF THE DRAWINGS

FIG. 1 is a block diagram for illustrating an electronic system according to one or more embodiments of the disclosure;

FIG. 2 is a diagram for illustrating generating and decrypting operations of a homomorphic encryption;

FIG. 3 is a block diagram illustrating a configuration of a server according to one or more embodiments of the disclosure;

FIG. 4 is a block diagram illustrating a configuration of an electronic apparatus according to one or more embodiments of the disclosure;

FIG. 5 and FIG. 6 are diagrams for illustrating operations according to the number of owners of training data according to one or more embodiments of the disclosure;

FIG. 7 is a diagram for illustrating an operation method according to one or more embodiments of the disclosure;

FIG. 8 is a flow chart for illustrating a control method of a server according to one or more embodiments of the disclosure; and

FIG. 9 is a flow chart for illustrating a control method of an electronic apparatus according to one or more embodiments of the disclosure.

### DESCRIPTION OF THE PREFERRED EMBODIMENT

Hereinafter, the disclosure will be described in detail with reference to the accompanying drawings. In the information (data) transmission process performed in the disclosure, encryption/decryption may be applied depending on needs, and all of the expressions explaining the information (data) transmission process in the disclosure and the claims should be interpreted to include cases of encrypting/decrypting, even if there is no separate mention in that regard. Also, in the disclosure, expressions in forms such as “transmit (transfer) from A to B” or “A receives from B” include a case wherein an object is transmitted (transferred) or received while another medium is included in between, and do not necessarily express only a case wherein an object is directly transmitted (transferred) from A to B or is received from B to A.

Also, in the description of the disclosure, the order of each step should be understood in a nonrestrictive way, unless a preceding step should necessarily be performed prior to a subsequent step in a logical and temporal sense. That is, excluding an exceptional case as above, even if a process described as a subsequent step is performed prior to a process described as a preceding step, there would be no influence on the essence of the disclosure, and the scope of the disclosure should also be defined regardless of the orders of steps. Further, the description “A or B” in the disclosure is defined to include not only a case wherein one of A or B is selectively referred to, but also a case wherein both of A and B are included. In addition, the term “include” in the disclosure includes a case wherein elements other than elements listed as being included are further included.

Further, in the disclosure, only essential elements necessary for describing the disclosure are described, and elements not related to the essence of the disclosure are not mentioned. Also, the descriptions of the disclosure should not be interpreted to have an exclusive meaning of including only the elements mentioned, but to have a non-exclusive meaning of also including other elements.

In addition, in the disclosure, “a module” or “a part” performs at least one function or operation, and may be implemented as hardware or software, or as a combination of hardware and software. Also, a plurality of “modules” or a plurality of “parts” may be integrated into at least one module and implemented as at least one processor (not shown), except “a module” or “a part” that needs to be implemented as specific hardware.

Further, in the disclosure, “a value” may be defined as a concept with broad meaning including not only scalar values, but also all values that can be expressed by mathematical formulae such as a vector, a matrix, a polynomial, etc.

Also, mathematical operations and calculations in each step of the disclosure that will be described below may be implemented as computer operations by coding methods that are known for performing the operations or the calculations and/or coding designed to be suitable for the disclosure.

In addition, the detailed mathematical formulae that will be explained below are explained as examples among several possible alternatives, and the scope of the disclosure should not be interpreted to be limited to the mathematical formulae mentioned in the disclosure.

For the convenience of explanation, the following descriptions are designated in the disclosure.
a←D: the element (a) is selected according to the distribution (D)
s₁, s₂∈R: Each of S1 and S2 is an element belonging to the R set.
mod(q): a modular operation is performed with the q element
┌-┘: the inner value is rounded off.

Hereinafter, various embodiments of the disclosure will be described in detail with reference to the accompanying drawings.

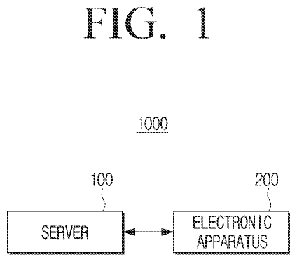

FIG. 1 is a block diagram for illustrating an electronic system 1000 according to one or more embodiments of the disclosure. As illustrated in FIG. 1, the electronic system 1000 includes a server 100 and an electronic apparatus 200.

The server 100 is an apparatus that stores a neural network model, and it may receive training data from the electronic apparatus 200 and train the neural network model. Here, the training data may have been homomorphically encrypted by the electronic apparatus 200. Here, training means the training of the neural network model. Here, the neural network model may be an initial model.

The server 100 may homomorphically encrypt the neural network model and acquire a homomorphic encryption corresponding to the neural network model, and transmit the homomorphic encryption to the electronic apparatus 200. In this case, training of the neural network model may be performed by the electronic apparatus 200.

The electronic apparatus 200 is an apparatus that stores training data, and it may be implemented as, for example, a smartphone, a tablet, a smart watch, a laptop, a PC, a home server, a kiosk, a home appliance to which an IoT function is applied, etc.

The electronic apparatus 200 may homomorphically encrypt the training data and acquire a homomorphic encryption corresponding to the training data, and transmit the homomorphic encryption to the server 100.

The electronic apparatus 200 may receive the homomorphic encryption wherein the neural network model was homomorphically encrypted from the server 100, and train the homomorphic encryption based on the training data.

As described above, each of the server 100 and the electronic apparatus 200 is an apparatus that can perform homomorphic encryption, and as they homomorphically encrypt a neural network model or training data, security can be maintained even if the data is provided to the other party.

However, the disclosure is not limited thereto, and the server 100 may store training data, and the electronic apparatus 200 may store a neural network model.

Hereinafter, for the convenience of explanation, homomorphic encryption will be explained first.

The processor of the server 100 or the processor of the electronic apparatus 200 (it will be described as the processor hereinafter) may homomorphically encrypt data (e.g., a neural network model, training data, etc., and they will be described as a message hereinafter) by using various kinds of parameters and programs, etc. stored in the memory. For example, the processor may convert a message into a polynomial form by using a predefined matrix (i.e., perform encoding), and encrypt the message converted into a polynomial form with a predetermined secret key, and generate a homomorphic encryption.

The processor may include an encryption noise calculated in the process of performing homomorphic encryption, i.e., an error in the encryption. Specifically, a homomorphic encryption generated by the processor may be generated in a form wherein a result value including a message and an error value is restored when the homomorphic encryption is decrypted by using a secret key afterwards.

For example, a homomorphic encryption generated by the processor may be generated in a form of satisfying the following formula 1 when it is decrypted by using a secret key.

Dec(ct, sk)=<ct, sk>=M+e(mod q) [Formula 1]

Here, <, > means a usual inner product, ct means an encryption, sk means a secret key, M means a plain text message, e means an encryption error value, and mod q means a modulus of the encryption. q should be selected to be bigger than M which is a result value of multiplying the message with a scaling factor (Δ). If the absolute value of the error value e is sufficiently smaller than M, the decryption value M+e of the encryption is a value that can replace the original message with the same precision in a significant figure operation. In the decrypted data, the error may be arranged on the side of the lowest bit (LSB), and M may be arranged on the side of the next lowest bit to be adjacent to the error.

In case the size of a message is too small or too big, the size may be adjusted by using a scaling factor. If a scaling factor is used, not only a message in an integer form but also a message in a real number form can be encrypted, and thus usability can be increased greatly. Also, as the size of a message is adjusted by using a scaling factor, the size of the area wherein messages exist, i.e., the effective area in an encryption after an operation was performed can also be adjusted.

Depending on embodiments, a modulus q of an encryption may be used while being set as various forms. For example, a modulus of an encryption may be set as a form of an exponentiation of a scaling factor Δ, q=Δ^{L}. If Δ is 2, the modulus may be set as a value such as q=2¹⁰.

Meanwhile, a public key may be used for encryption, and the processor may generate a public key necessary for performing encryption. However, the disclosure is not limited to this example, and a public key may be received from an external apparatus.

For example, the processor may generate a public key by using a Ring-LWE method. Specifically, the processor may first set various kinds of parameters and a ring, and store them in the memory. As examples of parameters, there may be the length of a plain text message bit, and the sizes of a public key and a secret key, etc.

Also, a ring may be expressed as the following formula 2.

$$R = {ℤ}_{q} [ x ] / ( f ( x ) ) \qquad [ Formula 2 ]$$

Here, R means a ring, Zq means a coefficient, and f(x) means an N-th polynomial.

A ring is a set of polynomials having predetermined coefficients, and means a set wherein an addition and a multiplication are defined among elements, and which is closed with respect to an addition and a multiplication. Such a ring may also be referred to as a ring.

As an example, a ring means a set of n-th polynomials of which coefficients are Zq. Specifically, when n is Φ(N), the ring means an N-th cyclotomic polynomial. (f(x)) means an ideal of Zq[x] generated as f(x). An Euler totient function Φ(N) means the number of natural numbers that are relative primes with N and are smaller than N. If Φ_{N}(x) is defined as an N-th cyclotomic polynomial, the ring may be expressed as the following formula 3.

$$R = {ℤ}_{q} [ x ] / ( {Φ}_{N} ( x ) ) \qquad [ Formula 3 ]$$

Meanwhile, a secret key (sk) may be expressed as follows.

Specifically, the ring in the formula 3 as above may have a complex number in a plain text space. Meanwhile, for improving the operation speed for a homomorphic encryption, only a set wherein a plain text space is a real number may be used among the sets of a ring as described above.

When the ring is set, the processor may calculate a secret key (sk) from the ring.

$$sk ← ( 1 , s ( x ) ) , s ( x ) ∈ {R}_{↵} \qquad [ Formula 4 ]$$

Here, s(x) means a polynomial generated randomly with a small coefficient.

Then, the processor may calculate a first random polynomial (a(x)) from the ring. The first random polynomial may be expressed as the following formula 5.

$$a ( x ) ← R \qquad [ Formula 5 ]$$

Also, the processor may calculate an error. Specifically, the processor may extract an error from a discrete Gaussian distribution or a distribution of which statistical distance is close to it. Such an error may be expressed as the following formula 6.

$$e ( x ) ← {𝒟}_{α q}^{n} \qquad [ Formula 6 ]$$

When the error is calculated, the processor may perform a modular operation of the error to the first random polynomial and the secret key, and calculate a second random polynomial. The second random polynomial may be expressed as the following formula 7.

$$b ( x ) = - a ( x ) s ( x ) + e ( x ) ( mod q ) . \qquad [ Formula 7 ]$$

Ultimately, the processor may generate a public key (pk) in a form of including the first random polynomial and the second random polynomial, as the following formula 8.

$$pk = ( b ( x ) , a ( x ) ) . \qquad [ Formula 8 ]$$

The key generation method described above is merely an example, and thus the disclosure is not necessarily limited to this example, and it is obvious that a public key and a secret key can be generated by methods other than this.

Meanwhile, when a public key is generated, the processor may transmit the public key to external apparatuses.

The processor may generate a homomorphic encryption for a message. Specifically, the processor may generate an encryption by using a public key pk=(b(x), a(x)) and the formula as follows to a message converted into a polynomial form.

$$Ctxt = ( v \cdot b ( x ) + Δ \cdot M + {e}_{0} , v \cdot a ( x ) + {e}_{1} ∈ R \times R \qquad [ Formula 9 ]$$

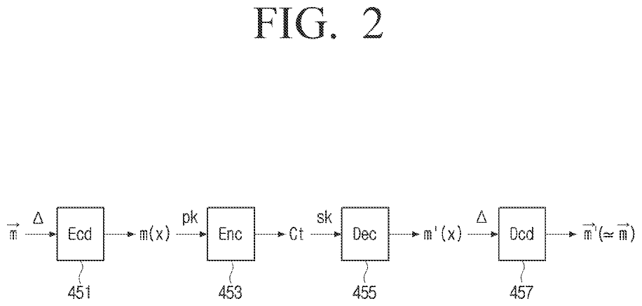

Here, the processor may generate the encryption so that the length of the encryption corresponds to the size of the scaling factor. Meanwhile, in case decryption for a homomorphic encryption is necessary, the processor may decrypt the homomorphic encryption by applying a secret key to the homomorphic encryption and generate a message. Here, the generated message may include an error as mentioned in the formula 1 explained above. A detailed decryption process and a detailed decoding operation will be described below with reference to FIG. 2.

The processor may perform an operation regarding an encryption. Specifically, the processor may perform an operation such as an addition or a multiplication while maintaining an encrypted state for a homomorphic encryption. Specifically, the processor may perform the first function processing for each of homomorphic encryptions to be used for an operation, and perform an operation such as an addition or a multiplication, etc. between the homomorphic encryptions for which the first function processing was performed, and perform the second function processing which is a reversed function of the first function for the homomorphic encryptions for which the operation was performed. For the first function processing and the second function processing as above, a linear conversion technology in a rebooting process to be described below may be used.

Meanwhile, when an operation is completed, the processor may detect data of the effective area from the operation result data. Specifically, the processor may perform rounding processing of the operation result data, and detect data of the effective area. The rounding processing means performing round-off of a message in an encrypted state, and alternatively, it may also be referred to as rescaling. Specifically, the processor may multiply the components of each encryption with Δ⁻¹ which is a reciprocal of a scaling factor and round it off, and remove the noise area. The noise area may be determined to correspond to the size of the scaling factor. As a result, the message in the effective area excluding the noise area may be detected. As this process proceeds in an encrypted state, an additional error may occur, but the error can be ignored as its size is sufficiently small.

Also, if the ratio of an approximation message in an encryption exceeds a threshold value as a result of an operation, the processor may perform a rebooting operation for the encryption.

As described above, the processor according to the disclosure can perform a decoding or an encoding operation by using a matrix of which size is smaller by half compared to a conventional matrix, and thus the processor can perform a faster decoding operation or a faster encoding operation. For example, the number of times of multiplications in the case of decoding for an homomorphic encryption wherein the polynomial degree is 17 is 2³³, and the number of times of multiplications in the case of encoding is 2³⁴, and if a matrix in a half size according to the disclosure is used, improvement of performance of approximately 5000 times or higher is possible.

Meanwhile, in the above, it was illustrated and explained that both of encrypting operations, i.e., encoding and encrypting operations are performed in one apparatus, but in actual implementation, only an encoding operation may be performed in one apparatus, and encryption may be performed by receiving the encoding result in another apparatus. Also, in a decryption process, both of a decrypting operation and a decoding operation may be performed in one apparatus, or a decrypting operation and a decoding operation may be performed individually in two apparatuses.

Further, while it was explained that an asymmetrical encryption method (i.e., a secret key and a public key) is used, but in actual implementation, encrypting and decrypting operations may be performed by a symmetrical encryption method.

FIG. 2 is a diagram for illustrating generating and decrypting operations of a homomorphic encryption.

Referring to FIG. 2, the processor may include an encoding module 451, an encryption module 453, a decryption module 455, and a decoding module 457.

If a message is input, the encoding module 451 may convert the received message into a polynomial form, and output the message. Here, the feature of outputting a message in a polynomial form means outputting a coefficient of a polynomial in a predetermined form, but in actual implementation, a polynomial itself may be output.

If a scaling factor for a message is input, the encoding module 451 may output a polynomial as the following formula 10.

$${m ( X ) = {τ}^{- 1} ( ⌊ Δ \cdot \vec{m} ⌉}_{τ ( {R}^{′} )} ) ∈ {R}^{′} \qquad [ Formula 10 ]$$

Here,

$$\vec{m} = {( {m}_{j} )}_{0 \leq j < n / 2} ∈ {ℝ}^{n / 2} ,$$

and it may be a message in a vector form. Also, m(x) is a message in a polynomial form, and for example, it is a form of m(X)=m₀+m₁X+ . . . +m_{N-1}X^{N-1}, and is an integer wherein mi∈[0, q−1]. These values may be expressed as vectors of a coefficient (m₀, m₁, . . . , m_{N-1}). Also, a message in a polynomial form may be referred to as a polynomial equation, and may have a degree of any one among 7th to 80th.

Meanwhile, in the above, only one message was converted into one polynomial, but in actual implementation, a plurality of messages may be converted into one polynomial. Such an operation may be referred to as packing.

If packing is used in homomorphic encryption, it becomes possible to encrypt a plurality of messages into one polynomial. In this case, if operations among each encryption are performed, operations for a plurality of messages will be processed in parallel ultimately, and thus burden for operations will become greatly reduced.

For example, in case a message consists of a plurality of message vectors, the encoding module 451 may convert the message into a polynomial in a form wherein the plurality of message vectors can be encrypted in parallel, and then perform homomorphic encryption.

Specifically, the encoding module 451 uses the feature that an N-th cyclotomic polynomial Φ_{N}(x) has roots

$${ζ}_{1} , \overline{{ζ}_{1}} , … , {ζ}_{n / 2} , \overline{{ζ}_{n / 2}}$$

(primitive N-th roots of unity) in the number of n=ϕ(N), which are different from one another within a complex number [symbol] . By introducing the concept of a complex number, it becomes possible to homomorphically encrypt a plurality of messages simultaneously as described above.

Next, a packing function σ may be calculated by modifying a canonical embedding function. The canonical embedding function is a function wherein a polynomial

$$M ( x ) ∈ ℝ [ x ] / {Φ}_{N} ( x ) )$$

is made to correspond to the pairs of values

$$( M ( {ζ}_{1} ) , … , M ( {ζ}_{n / 2} ) ) ∈ {ℂ}^{n / 2}$$

in the roots

$${ζ}_{1} , … , {ζ}_{n / 2}$$

in the number of (n/2), which are not in a complex conjugate relation among the roots

$${ζ}_{1} , \overline{{ζ}_{1}} , … , {ζ}_{n / 2} , \overline{{ζ}_{n / 2}} of {Φ}_{N} ( x ) .$$

A person having ordinary knowledge in the pertinent art will be able to easily prove that this function is an homomorphism.

If the canonical embedding function is expressed with the matrix C, it will be as follows.

$$( \begin{matrix}1 & {ζ}_{1} & … & {ζ}_{1}^{n - 1} \\ 1 & {ζ}_{2} & … & {ζ}_{2}^{n - 1} \\ ⋮ & ⋮ & ⋱ & ⋮ \\ 1 & {ζ}_{n / 2} & … & {ζ}_{n / 2}^{n - 1}\end{matrix} ) \qquad [ Formula 11 ]$$

If the polynomial M(x) is expressed as a column vector of coefficients M=(M₀, . . . , Mₙ₋₁), it may have a relation of C·M=σ(M) with the packing function σ(M)=(M(ζ₁), . . . , M(ζ_{n/2})) of this polynomial, i.e., a relation as follows.

$$( \begin{matrix}1 & {ζ}_{1} & … & {ζ}_{1}^{n - 1} \\ 1 & {ζ}_{2} & … & {ζ}_{2}^{n - 1} \\ ⋮ & ⋮ & ⋱ & ⋮ \\ 1 & {ζ}_{n / 2} & … & {ζ}_{n / 2}^{n - 1}\end{matrix} ) ( \begin{matrix}{M}_{0} \\ {M}_{1} \\ ⋮ \\ {M}_{n - 1}\end{matrix} ) = ( \begin{matrix}M ( {ζ}_{1} ) \\ M ( {ζ}_{2} ) \\ ⋮ \\ M ( {ζ}_{n / 2} )\end{matrix} ) \qquad [ Formula 12 ]$$

In a state of having calculated the canonical embedding function as above, if message vectors in a plural number (e.g., n/2)

$$m = ( {m}_{1} , … , {m}_{n / 2} ) ∈ {ℂ}^{n / 2}$$

are input, the encoding module 451 may convert the message vectors into a polynomial by using the aforementioned canonical embedding function.

$$M ( x ) = {σ}^{- 1} ( m ) \qquad [ Formula 13 ]$$

The polynomial M(x) converted by a method as the formula 13 satisfies a relation like

$$M ( {ζ}_{i} ) = {m}_{i} .$$

Meanwhile, the elements of the aforementioned canonical embedding function were expressed as from 1 to N, but the set may be expressed as [symbol] (j=0, 1, . . . N/2−1)). In this case, the matrix U used for DFT and iDFT may be expressed as follows.

$${U = [ \begin{matrix}1 & \text{?} & … & … & \text{?} & \text{?} \\ 1 & \text{?} & … & … & \text{?} & \text{?} \\ ⋮ & ⋮ & … & … & ⋮ & ⋮ \\ 1 & ⋮ & … & … & ⋮ & ⋮ \\ 1 & \text{?} & … & … & \text{?} & \text{?} \\ 1 & \text{?} & … & … & \text{?} & \text{?}\end{matrix} ] N / 2}^{{{N}_{─}}^{}} \qquad [ Formula 14 ]$$

$$\text{?} \text{indicates text missing or illegible when filed}$$

In this case, DFT may be defined as a vector of a complex number C^{N/2} which has a number of N/2 in the polynomial m(x), which is an element of R[x]/(X^{N}+1).

If a one-dimensional vector \vec{m} is defined as coefficients of m(X), the complex number vector z in an N/2 size which is a result of DFT may be calculated by using the following formula 15.

$$z {←}^{U \cdot {\vec{m}}^{h}} \qquad [ Formula 15 ]$$

iDFT is a method of calculating the vector \vec{m}=(m₀, m₁, . . . , m_{N-1}) containing the coefficients of the polynomial m(x) from the complex number vector z, and the vector may be calculated by the following method.

$$CRT {←}^{( \frac{U}{U} )} ( N \times N ) \qquad [ Formula 16 ]$$

Here, Ū is a matrix wherein all elements of U are conjugated.

$${\vec{m}}_{← CRT - 1} ( \frac{z}{z} ) \qquad [ Formula 17 ]$$

Meanwhile, in an encoding process or a decoding process, multiplications as much as the size of the matrix should be performed as described above, and accordingly, in a big homomorphic encryption environment wherein the degree of the polynomial is N, a large number of complex number multiplications are needed.

For example, in the case of using N=2¹⁷, multiplications in the number of times of 2³³ (when decoding) or 2³⁴ (when encoding) are needed.

Accordingly, if the size of a matrix can be reduced, the number of times of multiplications in an encoding process or a decoding process can be reduced. Accordingly, in the disclosure, an encoding or a decoding operation is performed by using a matrix having only half of the elements of the canonical embedding function, as in the formula 18.

$${{U}_{H =} \overbrace{[ \begin{matrix}1 & {ζ}_{0} & … & … & {ζ}_{0}^{N / 2 - 2} & {ζ}_{0}^{N / 2 - 1} \\ 1 & {ζ}_{1} & … & … & {ζ}_{1}^{N / 2 - 2} & {ζ}_{1}^{N / 2 - 1} \\ ⋮ & ⋮ & … & … & ⋮ & ⋮ \\ 1 & ⋮ & … & … & ⋮ & ⋮ \\ 1 & {ζ}_{N / 2 - 2} & … & … & {ζ}_{N / 2 - 2}^{N / 2 - 2} & {ζ}_{N / 2 - 2}^{N / 2 - 1} \\ 1 & {ζ}_{N / 2 - 1} & … & … & {ζ}_{N / 2 - 1}^{N / 2 - 2} & {ζ}_{N / 2 - 1}^{N / 2 - 1}\end{matrix} ]} N / 2}^{N / 2} \qquad [ Formula 18 ]$$

Such a matrix (UH) is a matrix having only the half value on the left side of the canonical embedding function, and the row number is the same as that of the canonical embedding function, and the column number is the half.

Functions τ and τ⁻¹ in the case of using such a matrix can be defined as follows.

$$τ ( {m}^{\text{?}} ) = {U}_{H} ⋆ {m}^{\text{?}} ( {m}^{\text{?}} = ( {m}_{0} + i ⋆ {m}_{N / 2} , … , {m}_{\text{?}} + i ⋆ {m}_{N / 2} ← , … ) ( j = 0 , … N / 2 - 1 ) \qquad [ Formula 19 ]$$

$$\text{?} \text{indicates text missing or illegible when filed}$$

Here, mᵢ is the coefficient of the random polynomial m(X)=m0+m1 X+ . . . which is the element of R[x]/(XN+1).

$${τ}^{- 1} ( \text{?} ) = {U}_{H}^{- 1} ⋆ v \qquad [ Formula 20 ]$$

$$\text{?} \text{indicates text missing or illegible when filed}$$

Here, Ū_{H}⁻¹=(1/(N/2))*Ū_{H}².

For the reasons as in the formulae 19 and 20, U_{H} and U_{H}⁻¹ may be used in calculating τ and τ⁻¹. Specifically, a matrix value in a matrix corresponding to the canonical embedding function may be expressed as in the formula 21, and the absolute value of the size of each matrix value is identical by a predetermined cycle. For example, each matrix value may have a value wherein the size is identical by the cycle of 5 and only the code value is changed. In this aspect, an encoding or a decoding operation may be performed by using a matrix which has only the half value on the left side of the canonical embedding function.

For the reasons as in the following formulae 21 to 24, FFT and iFFT can be applied when calculating τ and τ⁻¹ using DFT. For example, the aforementioned calculation of a matrix may be used by using a Cooley-Tukey FFT algorithm method.

$${ζ}_{k}^{j} = {( {e}^{2 π i / 2 N} )}^{( {5}^{k} mod 2 N ) j} = {( {e}^{2 π i / 2 N} )}^{( 4 k + 1 ) j} \qquad [ Formula 21 ]$$

$${ζ}_{k + \frac{N}{1}}^{j} {( {e}^{2 π i / 2 N} )}^{( 4 ( k + \frac{N}{1} + 1 ) j} - {( {e}^{2 π i / 2 N} )}^{( 4 k + 1 ) j} \qquad [ Formula 22 ]$$

$${ζ}_{k}^{j} = {( {e}^{2 π i / \begin{matrix}2 N \\ 2\end{matrix}} )}^{( 4 k + 1 ) ( j / 2 )} \qquad [ Formula 23 ]$$

(here, j is an odd number)

$${U}_{H}^{- 1} = {\frac{\frac{1}{N}}{2}}^{{\overline{U}}_{H}^{T}} \qquad [ Formula 24 ]$$

Also, when performing such a calculation of a matrix, FFT and iFFT can be applied when calculating τ and τ⁻¹ using DFT. For example, if the complexity is O(N2) when using a conventional matrix (U), in the case of using the matrix (U_{H}) according to the disclosure, the complexity O(N log N) is reduced, and in case N=2¹⁷, improvement of performance of approximately 5000 times can be generated.

Afterwards, a scaling factor may be applied to the message converted into a polynomial. In this case, the scaling factor may be applied by multiplying each coefficient of the converted polynomial with the scaling factor.

Then, the encryption module 453 may receive the message in a polynomial form, and reflect the public key to the received message and generate a homomorphic encryption. Specifically, a homomorphic encryption may be generated by using the following formula 25.

$$v \cdot pk + ( m + {e}_{0} , {e}_{1} ) ( mod {q}_{L} ) \qquad [ Formula 25 ]$$

Here, v is an element selected according to Xenc, and e0 and e1 are also error values selected according to Xerr.

The decryption module 455 may receive input of an encryption and a secret key, and decrypt the encryption and output a message including an error (referred to as an approximation message hereinafter). Specifically, in case an input encryption is ct=(c₀, c₁)∈R′_{q}_{ₗ}², the decryption module 455 may output a message such as m′=c₀+c₁·s(mod qₗ).

Meanwhile, as a message output from the decryption module 455 is a message in a polynomial form, the decoding module 457 may ultimately output a message based on the message output from the decryption module 455 and the scaling factor.

Specifically, in case a polynomial message satisfies

$$m ( X ) ∈ {R}^{′} ,$$

the decryption module 455 may output a message such as

$$\vec{m} = {( {m}_{j} = {Δ}^{- 1} \cdot m ( {ζ}_{j} ) )}_{0 \leq j < n / 2} ∈ {ℝ}^{n / 2} .$$

Here, the decryption module 455 may perform a DFT operation by using the matrix as in the formula 15 which has only half of the elements of the canonical embedding function described above.

Meanwhile, in the illustrated example, it was illustrated and explained that the processor includes all of the four modules, but in actual implementation, the processor may include only the encoding module and the encryption module, or include only the decryption module and the decoding module. Also, in actual implementation, the processor may include only any one module among the four modules.

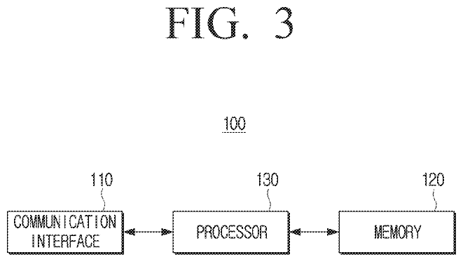

FIG. 3 is a block diagram illustrating a configuration of the server 100 according to one or more embodiments of the disclosure.

The server 100 includes a communication interface 110, a memory 120, and a processor 130.

The communication interface 110 includes circuitry. The communication interface 110 may communicate with an external apparatus (e.g.: an electronic apparatus 200, etc.) through a network, and transmit various kinds of information or data to the external apparatus or receive various kinds of information or data from the external apparatus. Such a communication interface 110 may also be referred to as a transceiver.

For example, the communication interface 110 may include a wired LAN communication module like an Ethernet module. Also, the communication interface 110 may include a wireless communication module such as WiFi (e.g.: WiFi 802.11a/b/g/n), Bluetooth, Zigbee, NFC, infrared communication, etc. In addition, the communication interface 110 may include a cellular communication module such as 3rd Generation (3G), 3rd Generation Partnership Project (3GPP), Long Term Evolution (LTE), 5G, etc. Also, the communication interface 110 may include a wired communication module such as a high-definition multimedia interface (HDMI), a universal serial bus (USB), etc.

As described above, the communication interface 110 may communicate with an external apparatus by using at least one of various types of communication methods.

The memory 120 may store data necessary for the server 100 to operate according to the various embodiments of the disclosure.

For example, the memory 120 may store an O/S for driving the server 100, various kinds of software and data, etc. Also, in the memory 120, at least one instruction may be stored. Such a memory 120 may be implemented in various forms such as a RAM, a ROM, a flash memory, an HDD, an external memory, a memory card, etc., and is not limited to any one.

Also, in the memory 120, a message to be encrypted (e.g.: homomorphic encryption) may be stored. For example, a message may be a neural network model.

In addition, in the memory 120, a public key may be stored. In case a public key is generated by the server 100, in the memory 120, not only the public key and a secret key, but also various kinds of parameters necessary for generating the public key and the secret key may be stored.

Further, the memory 120 may store a homomorphic encryption generated in the server 100. Also, the memory 120 may store intermediate data (e.g., a message vector, a message in a polynomial form, etc.) in the process of generating the homomorphic encryption.

Also, the memory 120 may store an encryption which is a result of an operation. An encryption which is a result of an operation may mean a result value acquired through an operation process for a homomorphic encryption. Such an operation process may be performed by the server 100 or the electronic apparatus 200.

The processor 130 may be connected with each component of the server 100, and control the overall operations of the server 100. For example, the processor 130 may be connected with the communication interface 110 and the memory 120, and control the server 100. Such a processor 130 may be constituted as a single device such as a central processing unit (CPU) and an application-specific integrated circuit (ASIC), or constituted as a plurality of devices such as a CPU, a graphics processing unit (GPU), etc.

Also, the processor 130 may perform the operations of the server 100 according to the various embodiments of the disclosure by executing the at least one instruction stored in the memory 120.

First, an embodiment wherein the electronic apparatus 200 homomorphically encrypts training data and provides the data to the server 100 (referred to as a first embodiment hereinafter) will be described, and then an embodiment wherein the server 100 homomorphically encrypts a neural network model and provides the neural network model to the electronic apparatus 200 (referred to as a second embodiment hereinafter) will be described.

The processor 130 may receive, through the communication interface 110, a homomorphic encryption wherein training data is homomorphically encrypted from the electronic apparatus 200, and train a first neural network model stored in the memory 120 based on the homomorphic encryption and acquire a second neural network model.

The processor 130 may perform an addition operation of a random value to the second neural network model and acquire a third neural network model, and control the communication interface 110 to transmit the third neural network model to the electronic apparatus 200. For example, the processor 130 may perform an addition operation of a plurality of random values to each of a plurality of weights included in the second neural network model and acquire the third neural network model. For example, all values of the plurality of random values may be different. Through such an operation, security of the neural network model can be secured.

The processor 130 may receive, through the communication interface 110, a fourth neural network model decrypted from the third neural network model from the electronic apparatus 200, and perform a subtraction operation of the random value to the fourth neural network model and acquire a final neural network model. For example, the processor 130 may perform a subtraction operation of the plurality of random values to each of a plurality of weights included in the fourth neural network model and acquire the final neural network model. Here, the plurality of random values are identical to the values used in the addition operation.

The final neural network model acquired through such a method may be a neural network model trained from the first neural network model based on the training data. That is, training of the neural network model is possible even when homomorphically encrypted training data is received, and as the server 100 cannot identify the original copy of the training data, security of the training data can be secured.

In the above, for the convenience of explanation, it was explained that homomorphically encrypted training data is received from one electronic apparatus 200, but a plurality of training data may be needed for training of a neural network model.

In this case, the processor 130 may receive, through the communication interface 110, a plurality of homomorphic encryptions from each of a plurality of electronic apparatuses, train the first neural network model based on each of the plurality of homomorphic encryptions and acquire a plurality of second neural network models, perform an addition operation of the random value to each of the plurality of second neural network models and acquire a plurality of third neural network models, control the communication interface 110 to transmit each of the plurality of third neural network models to the plurality of electronic apparatuses, receive, through the communication interface 110, the plurality of fourth neural network models decrypted from each of the plurality of third neural network models from each of the plurality of electronic apparatuses, perform a subtraction operation of the random value to each of the plurality of fourth neural network models and acquire a plurality of fifth neural network models, and perform weighted averaging of the plurality of fifth neural network models and acquire a final neural network model.

Here, the processor 130 may receive, through the communication interface 110, information on the number of training data of each of the plurality of electronic apparatuses from the plurality of electronic apparatuses, and perform weighted averaging of the plurality of fifth neural network models based on the received information. For example, in case the first training data of the first electronic apparatus among the plurality of electronic apparatuses is twice more than the first training data of the second electronic apparatus among the plurality of electronic apparatuses, the processor 130 may determine the weight of the first neural network model acquired through the first training data as twice more than the weight of the second neural network model acquired through the second training data, and then perform weighted averaging.

In the above, for the convenience of explanation, explanation regarding an operation key, etc. was omitted, but the disclosure is not limited thereto.

For example, the processor 130 may receive, through the communication interface 110, an operation key and the homomorphic encryption wherein the training data is homomorphically encrypted with an encryption key corresponding to the operation key from the electronic apparatus 200, train the first neural network model based on the homomorphic encryption and the operation key and acquire the second neural network model, perform an addition operation of the random value to the second neural network model and acquire the third neural network model, control the communication interface 110 to transmit the third neural network model to the electronic apparatus 200, receive, through the communication interface 110, the fourth neural network model decrypted from the third neural network model based on a decryption key corresponding to the operation key from the electronic apparatus 200, and perform a subtraction operation of the random value to the fourth neural network model and acquire the final neural network model.

Meanwhile, in the case of operating as the second embodiment, the processor 130 may homomorphically encrypt the neural network model stored in the memory 120 and acquire a homomorphic encryption, control the communication interface 110 to transmit the homomorphic encryption to the electronic apparatus 200, receive, through the communication interface 110, the homomorphic encryption trained based on the training data from the electronic apparatus 200, and decrypt the trained homomorphic encryption and acquire a final neural network model.

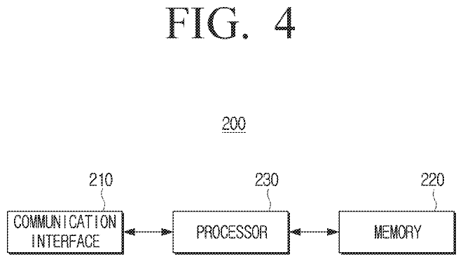

FIG. 4 is a block diagram illustrating a configuration of the electronic apparatus 200 according to one or more embodiments of the disclosure.

The electronic apparatus 200 includes a communication interface 210, a memory 220, and a processor 230.

The communication interface 210 includes circuitry. The communication interface 210 may communicate with an external apparatus (e.g.: the server 100, etc.) through a network, and transmit various kinds of information or data to the external apparatus or receive various kinds of information or data from the external apparatus. Such a communication interface 210 may also be referred to as a transceiver.

For example, the communication interface 210 may include a wired LAN communication module like an Ethernet module. Also, the communication interface 210 may include a wireless communication module such as WiFi (e.g.: WiFi 802.11a/b/g/n), Bluetooth, Zigbee, NFC, infrared communication, etc. In addition, the communication interface 210 may include a cellular communication module such as 3rd Generation (3G), 3rd Generation Partnership Project (3GPP), Long Term Evolution (LTE), 5G, etc. Also, the communication interface 210 may include a wired communication module such as a high-definition multimedia interface (HDMI), a universal serial bus (USB), etc.

As described above, the communication interface 210 may communicate with an external apparatus by using at least one of various types of communication methods.

The memory 220 may store data necessary for the electronic apparatus 200 to operate according to the various embodiments of the disclosure.

For example, the memory 220 may store an O/S for driving the electronic apparatus 200, various kinds of software and data, etc. Also, in the memory 220, at least one instruction may be stored. Such a memory 220 may be implemented in various forms such as a RAM, a ROM, a flash memory, an HDD, an external memory, a memory card, etc., and is not limited to any one.

Also, in the memory 220, a message to be encrypted (e.g.: homomorphic encryption) may be stored. For example, a message may be training data.

In addition, in the memory 220, a public key may be stored. In case a public key is generated by the electronic apparatus 200, in the memory 220, not only the public key and a secret key, but also various kinds of parameters necessary for generating the public key and the secret key may be stored.

Further, the memory 220 may store a homomorphic encryption generated in the electronic apparatus 200. Also, the memory 220 may store intermediate data (e.g., a message vector, a message in a polynomial form, etc.) in the process of generating the homomorphic encryption.

Also, the memory 220 may store an encryption which is a result of an operation. An encryption which is a result of an operation may mean a result value acquired through an operation process for a homomorphic encryption. Such an operation process may be performed by the server 100 or the electronic apparatus 200.

The processor 230 may be connected with each component of the electronic apparatus 200, and control the overall operations of the electronic apparatus 200. For example, the processor 230 may be connected with the communication interface 210 and the memory 220, and control the electronic apparatus 200. Such a processor 230 may be constituted as a single device such as a central processing unit (CPU) and an application-specific integrated circuit (ASIC), or constituted as a plurality of devices such as a CPU, a graphics processing unit (GPU), etc.

Also, the processor 230 may perform the operations of the electronic apparatus 200 according to the various embodiments of the disclosure by executing the at least one instruction stored in the memory 220.

In the case of operating as the first embodiment, the processor 230 may homomorphically encrypt training data stored in the memory 220 and acquire a homomorphic encryption, control the communication interface 210 to transmit the homomorphic encryption to the server 100, receive, through the communication interface 210, a neural network model wherein an addition operation of a random value was performed to a neural network model trained based on the homomorphic encryption from the server 100, decrypt the neural network model wherein an addition operation of the random value was performed, and control the communication interface 210 to transmit the decrypted neural network model to the server 100. As the training data is homomorphically encrypted, security can be secured. Also, as the neural network model is received while a random value is added, security can be secured.

In the above, for the convenience of explanation, explanation regarding an operation key, etc. was omitted, but the disclosure is not limited thereto.

For example, the processor 230 may acquire an encryption key, a decryption key, and an operation key based on a homomorphic encryption algorithm, and homomorphically encrypt the training data based on the encryption key and acquire the homomorphic encryption, control the communication interface 210 to transmit the homomorphic encryption and the operation key to the server 100, receive, through the communication interface 210, a neural network model wherein an addition operation of the random value was performed to a neural network model trained based on the homomorphic encryption and the operation key from the server 100, decrypt the neural network model wherein an addition operation of the random value was performed based on the decryption key, and control the communication interface 210 to transmit the decrypted neural network model to the server 100.

In the case of operating as the second embodiment, the processor 230 may receive, through the communication interface 210, a homomorphic encryption wherein a neural network model is homomorphically encrypted from the server 100, train the homomorphic encryption based on the training data stored in the memory 220, and control the communication interface 210 to transmit the trained homomorphic encryption to the server 100.

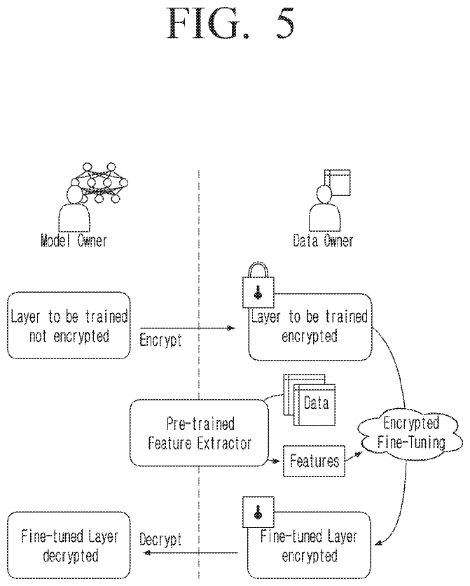

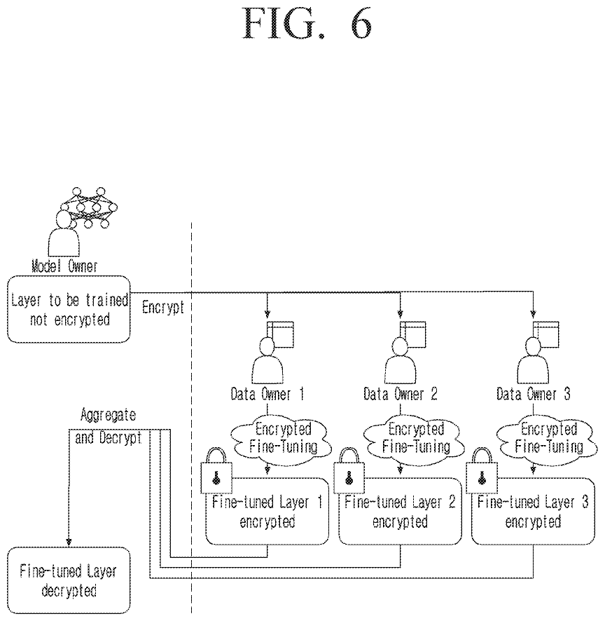

FIG. 5 and FIG. 6 are diagrams for illustrating operations according to the number of owners of training data according to one or more embodiments of the disclosure.

First, explaining about transfer learning briefly, transfer learning is mainly focused on a classification job of multiple classes, and may adopt the most general access method. In transfer learning, a pre-trained model may be used as a function extractor, and the classification hierarchy may be finely adjusted. Also, for minimizing the Cross-Entropy Loss LCE, layers may be trained with Stochastic Gradient Descent (SGD). For example, n, f, c may respectively be the mini arrangement size, the feature number, and the class number (the number of the features may be identical to the output dimension of the pre-trained feature extractor).

Also,

$$X = ( {x}_{ij} ) ∈ {ℝ}^{n \times ( f + 1 )} , {Y}^{\text{?}} = ( {y}_{ik} ) {ℝ}^{n \times c}$$

$$\text{?} \text{indicates text missing or illegible when filed}$$

may respectively be defined as a matrix indicating an input function and a one-hot encoding label of mini arrangement data, and

$$W = ( {w}_{kj} ) ∈ {ℝ}^{c \times ( f + 1 )}$$

may be defined as a parameter matrix. It can be assumed that the last column of W is a bias column, and a corresponding column of X is filled with 1. The probability that ith data would belong to the kth class may be modeled as a softmax function as follows.

$${p ( X ; W )}_{ik} - {Softmax ( {X}_{i} {W}^{T} )}_{k} \qquad [ Formula 26 ]$$

Here,

$${X}_{i} ∈ {ℝ}^{f + 1}$$

is the ith row of X, and if it is expressed as

$$P = ( {p ( X ; W )}_{jk} ) ∈ {ℝ}^{a \times c} ,$$

the gradient ∇_{W} [symbol] _{CE} of the Cross-Entropy Loss LCE for W is as follows.

$${∇}_{W} {ℒ}_{CE} = \frac{1}{n} {( P - Y )}^{⊤} X \qquad [ Formula 27 ]$$

Meanwhile, Homomorphic Encryption (HE) may be an encryption primitive that can support a calculation for data encrypted without decryption. In particular, a CKKS method may support an approximate arithmetic operation for a real number vector and a complex number vector encrypted by a homomorphic encryption method. A slot is each item of a vector existing in an encryption wherein an encrypted value is compressed, and a block of an encryption may consist of several slots.

Through this, HE may support a single instruction multiple data (SIMD) job and execute calculations for several pieces of data at once, and the following jobs may become possible through encryptions.

Addition: Add each element of two encryptions.

Multiplication: Multiply each element of two encryptions.

An encryption-an encryption multiplication is indicated as a Mult, and a plain text-an encryption multiplication is indicated as a CMult, and a multiplication of x and y is indicated as x⊙y regardless of whether x and y are encrypted. As the CKKS method is a homomorphic encryption method, a multivariate polynomial of a limited multiplicative depth may be calculated. Multiplying a random complex constant may also consume a depth.

Rotation: If a message m=(z₀, . . . , zₛ₋₁)∈ [symbol] ^{s} and its encryption ct are given, ctᵣₒₜ=Lrot(ct, x) may be calculated for 0≤x<s, and encryption release may be (zᵣ, . . . , zₛ₋₁, z₀, . . . , zᵣ₋₁).

### Complex Conjugation: Complex Utilization of Each Element of an Encryption

Bootstrapping: Bootstrapping is a unique job that can calculate a multivariate polynomial of a random angle, and is a calculation that costs the most among all basis operations of a homomorphic encryption, and thus it may be important to reduce the multiplication depth of a circuit for reducing the number of bootstrapping operations.

In FIG. 5 and FIG. 6, there may be one owner of the neural network model. Here, the owner of the neural network model may be the Model Owner (MO).

First, as illustrated in FIG. 5, there may be one owner of the training data (HETAL-SDO). Here, the owner of the training data may be the Data Owner (DO).

In this case, the server 100 may homomorphically encrypt the neural network model and provide the neural network model to the electronic apparatus 200, and the electronic apparatus 200 may train the neural network model based on the training data, and then provide the trained neural network model to the server 100, and the server 100 may acquire a final neural network model through decryption. This may be expressed as a protocol as follows.

Protocol 1 HETAL for single DO (HETAL-SDO)

Set t ← 0.
while True do

| | |
|---|---|
| 1. | MO encrypts and sends model's parameters W_{ct,t} to DO. |
| 2. | DO updates the parameter W_{ct,t} on β (DO's data, split into |
| | mini-batches of size n) using SGD: |
| | (a) For (Xₚₜ, Yₚₜ) ← β, update W_{ct,t} as |
| | ${W}_{ct , t} ← {W}_{ct , t} - \frac{α}{n} {( {P}_{ct , t} - {Y}_{p t} )}^{T} {X}_{p t}$ |
| | where P_{ct} = ASoftmax(XₚₜW_{ct,t}^{T}) with softmax approximation |
| | ASoftmax and a learning rate [symbol] . |
| | (b) Repeat (a) for several iterations, and DO gets a fine- |
| | tuned local model with encrypted parameter W_{ct,t+1}. |
| 3. | DO sends a fine-tuned model W_{ct,t+1} to MO. |
| 4. | MO decrypts the model to get a final model W_{pt,t+1}. |
| 5. | Once the model is sufficiently trained, break the loop. |
| 6. | t ← t +1. |

end while [symbol]
indicates data missing or illegible when filed

Alternatively, the electronic apparatus 200 may homomorphically encrypt the training data and provide the training data to the server 100, and the server 100 may train the neural network model based on the homomorphically encrypted training data, and then perform an addition operation of a random value to the trained neural network model, and provide the neural network model wherein an addition operation was performed to the electronic apparatus 200. The electronic apparatus 200 may decrypt the neural network model wherein an addition operation was performed, transmit the decrypted neural network model to the server 100, and the server 100 may perform a subtraction operation of the random value to the decrypted neural network model and acquire a final network model.

Meanwhile, as illustrated in FIG. 6, there may be a plurality of owners of the training data (HETAL-FL). That is, federated learning (FL) may be performed.

In this case, the server 100 may homomorphically encrypt the neural network model and provide the neural network model to a plurality of electronic apparatuses, and each of the plurality of electronic apparatuses may train the neural network model based on the training data, and then provide the trained neural network model to the server 100, and the server 100 may decrypt the plurality of neural network models, and perform weight averaging of the plurality of decrypted neural network models and acquire a final network model. This may be expressed as a protocol as follows.

Protocol 2 HETAL for federated learning (HETAL-FL)

Set t ← 0.
while True do

| | |
|---|---|
| 1. | MO encrypts and distributes model's parameters W_{ct,} [symbol] to |
| | DOᵢ, for 1 ≤ i ≤ C. |
| 2. | Each DOᵢ trains the parameter W_{ct,} [symbol] on βᵢ (DOᵢ's data, |
| | also split into mini-batches of size n) using SGD: |
| | (a) For (Xₚₜ, Yₚₜ) ← βᵢ, update W [symbol] as |
| | ${W}_{ct , i , t} ← {W}_{ct , i , t} - \frac{α}{n} {( {P}_{ct} - {Y}_{p t} )}^{T} {X}_{p t}$ |
| | where P_{ct} = ASoftmax(Xₚₜ W_{ct,i}^{T}). |
| | (b) Repeat (a) for several local iterations, and DOᵢ gets a |
| | fine-tuned local model W_{ct,i,t+1}. |
| 3. | DOᵢ sends a fine-tuned model W_{ct,i,t+1} to MO. |
| 4. | MO decrypts the weights as W_{pt,i,t+1} and aggregates the weights |
| | to get the final weight |
| | ${W}_{p t , t + 1} = {\sum }_{i = 1}^{C} \frac{{N}_{i}}{N} {W}_{p t , i , i + 1}$ |
| | where Nᵢ is the number of data that DOᵢ holds and N = |
| | Σᵢ₌₁^{C} Nᵢ is the total number of data. |
| 5. | Once the model is sufficiently trained, break the loop. |
| 6. | t ← t +1. |

end while [symbol]
indicates data missing or illegible when filed

Alternatively, each of the plurality of electronic apparatuses may homomorphically encrypt the training data and provide the training data to the server 100, and the server 100 may train the neural network model based on the plurality of homomorphically encrypted training data, and then perform an addition operation of a random value to the plurality of trained neural network models, and provide each of the plurality of neural network models wherein an addition operation was performed to the corresponding electronic apparatus. Also, each of the plurality of electronic apparatuses may decrypt the neural network model wherein an addition operation was performed, and transmit the decrypted neural network model to the server 100, and the server 100 may perform a subtraction operation of the random value to the plurality of decrypted neural network models, and perform weighted averaging of the plurality of neural network models wherein a subtraction operation was performed and acquire a final neural network model.

Through operations as above, an effective Homomorphic Encryption based Transfer Learning Algorithm (HETAL) using the CKKS homomorphic encryption technic may be implemented.

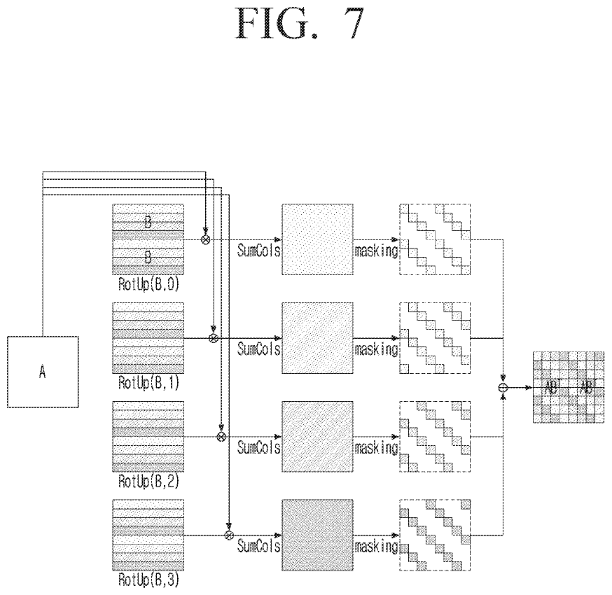

FIG. 7 is a diagram for illustrating an operation method according to one or more embodiments of the disclosure.

A softmax approximation algorithm, and DiagABT and DiagATB, which are two new kinds of encryption matrix multiplication algorithms for calculating matrix multiplications in AB^{τ} and A^{τ}B forms will be explained. FIG. 7 illustrated the DiagABT algorithm.

### Softmax Approximation

After an exponential function and an inverse function are individually approximated (indicated as AExp and Ainv), Asoftmax which is the final approximation value of softmax may be acquired as follows by combining the functions.

$$ASoftmax ( {z}_{1} , … , {z}_{c} ) := AInv ( Z ) ( AExp ( {z}_{1} ) , … , AExp ( {z}_{c} ) ) , \qquad [ Formula 28 ]$$

$$Z = {\sum }_{k = 1}^{c} AExp ( {z}_{k} ) .$$

In the case of an exponent, an exponent for [−1, 1] may be approximated with a polynomial of a degree d=12 by a least square method first, and the approximation area may be extended to [−B, B] by using a relation |exp(x)=exp(x/B)^{B}. For approximating the reverse value, an algorithm of Goldschmidt may be used, and n=8 (the number of times of repetition) and R=104 (a scaling coefficient) may be used. Lastly, by using the Gumbel softmax technology of dividing an input by a fixed constant λ=4, the range of the exponent may be reduced, and may be made to fit the area of the reverse approximation.

However, as training proceeds, the input range of softmax may increase, and it may not be sufficient for training an epoch that originally has a lot of parameters, and thus the following set of parameters may be used.

d=8. This can reduce the number of Mults and Cmults without loss of precision.

B=8. This can reduce the multiplication depth by 1 compared to the original B=16=2⁴.

R=2¹⁸, n=20. R has been increased with respect to a bigger approximation area, and errors will increase if R increases, and thus a bigger n was selected for better precision.

λ=1. The Gumbel softmax technology is not used.

If parameters as above are used, a model wherein there is almost no loss of precision can be acquired, compared to training that is not encrypted.

### Encrypted Matrix Multiplication

First, a method of encoding a matrix into an encryption and a method of performing an encrypted matrix multiplication in AB^{τ} and A^{τ}B forms for calculating logits and gradients in HETAL will be explained. Including a transpose in a multiplication may be more effective than directly calculating a matrix multiplication in an AB form. The reason for this is that, as a transpose should be performed with respect to each repetition of training, it will cost a lot, and an additional multiplication depth will have to be consumed.

### Encoding

A matrix generally has a big size, and for example, there may be a lot of cases wherein there are more items than the number of the slots of a single encryption. That is, for encoding such a big matrix, several blocks (encryptions) are necessary, and for this, the matrix may be divided into submatrices of s₀×s₁ in fixed forms first, and then each submatrix may be encoded in the order of row-major. Here, each submatrix corresponds to a single encryption, and thus the number of the items of each submatrix may be identical to the number of the slots of the single encryption (i.e., s₀s₁=s). Accordingly, for encoding a matrix in an a×b form,

$$⌈ \frac{a}{{s}_{0}} ⌉ \times ⌈ \frac{b}{{s}_{1}} ⌉$$

may be needed.

For the convenience of explanation, it will be assumed that all matrices are sufficiently small such that they can be included in one encryption, and if necessary, it will be additionally assumed that the numbers of the rows and the columns of a matrix is the power of 2 by applying zero padding. An algorithm may be easily extended to a big matrix (consisting of several encryptions).

### Operation of AB^{τ}

If A∈ [symbol] ^{a×b} and B∈ [symbol] ^{c×b} are assumed as two matrices, AB^{τ}∈ [symbol] ^{a×c} should be operated by using basic HE operations such as an addition, a multiplication, a rotation, etc.

The matrix B′ which was acquired by rotating the row of B in RotUp(B, K) as much as k in the upper direction with respect to the given matrix B is defined (e.g., B′_{i,j}=B_{(i+k)mod c,j′}).

When encoding B in the row direction, if only a left rotation of the index kb is applied, RotUp(B, K) may be acquired from B. That is, RotUp(B, k)=Lrot(B, kb).

Next, with respect to the s₀×s₁ matrix X, SumCols(X) may be defined as a matrix having items.

$${SumCols ( X )}_{i , j} = {\sum }_{0 \leq k < {s}_{1}} {X}_{i , k} . \qquad [ Formula 29 ]$$

That is, each column of SumCols(X) may be the sum of the X column, and this may be calculated with a rotation of 2 log s₁ and a multiplication of a constant 1.

The matrix B̅ may be defined as the s₀×b matrix. Here, the copy of (s₀/c) of B may be tiled in a vertical direction, and B̅_{cplx} which is the complexification of B̅ may be defined as follows.

$${\overline{B}}_{cp \vert x} = \overline{B} + \sqrt{- 1} RotUP ( \overline{B} , c / 2 ) . \qquad [ Formula 30 ]$$

(Multiplying i=\sqrt{−1} would not consume a multiplication depth.) By using this, AB̅^{τ} may be calculated as follows. AB̅^{τ} may be a matrix including the copy of (s₁/c) of AB^{τ} in a horizontal direction.

### Proposition 1

If A and B are defined as above, AB̅^{τ}=X+Conj(X) may be acquired by the following.

$$X = {\sum }_{0 \leq k < c / 2} SumCols ( A ⊙ RotUp ( {\overline{B}}_{cp \vert x} , k ) ) ⊙ {M}_{cp \vert x}^{( k , c )} . \qquad [ Formula 31 ]$$

Here, M^{(k,d)} may be an off-diagonal masking matrix according to the following.

$${M}_{i , j}^{( k , d )} = \{ \begin{matrix}1 & j ≡ i + k ( mod d ) \\ 0 & otherwise\end{matrix} \qquad [ Formula 32 ]$$

M_{cplx}^{(k,c)} may be a complexified version of the masking matrix.

$${M}_{cp \vert x}^{( k , c )} = \frac{1}{2} {M}^{( k , c )} - \frac{\sqrt{- 1}}{2} {M}^{( k + c / 2 , c )} \qquad [ Formula 33 ]$$

FIG. 7 describes the Proposition 1. The number of rotations indicates a bottleneck phenomenon of a matrix multiplication, and tiling has an effect of reducing from O(s₀ log s₁) to O(c log s₁). This is also appropriate for a case of calculating XW^{τ}, as the number of rows of W is the same as the number of classes of the data set, and in general, it may be smaller than s₀ or s₁. Also, if complexification is used, the complexity may be further reduced by half from O(c log s₁) to O(c/2 log s₁). Lastly, the algorithm may be extended so that, by replacing the diagonal mask M_{cplx}^{(k,c)} with tM_{cplx}^{(k,c)}, tAB^{τ} with respect to t∈R can be calculated without consumption of an additional multiplication depth.

### Operation of A^{τ}B

If it is assumed that A∈ [symbol] ^{a×c} and B∈ [symbol] ^{a×b}, A^{τ}B may be operated in a similar manner. First, the matrix A′ which was acquired by rotating the column of A in RotLeft(A, k) as much as k in the left direction is defined (e.g., A′_{i,j}=A_{i,(j+k)mod c′}).

This may be a job that is intrinsically identical to the permutation φ. Unlike RotUp, a multiplication depth may be used. Like SumCols, SumRows(X) with respect to the s₀×s₁ matrix X may be defined as follows.

$${SumRows ( X )}_{i , j} = {\sum }_{0 \leq k < {s}_{0}} {X}_{k , j} . \qquad [ Formula 34 ]$$

That is, each row of SumRows(X) may be the sum of the rows in X, and this may be performed with a rotation of log s₀ without consumption of an additional depth.

Like in the case of AB^{τ}, tiling and complexification may be applied to reduce computational complexity. The a×s₁ matrix wherein the copy of (c/s1) of A is tiled in a horizontal direction may be indicated as A. Also, A_{cplx} which is the complexification of A may be defined as follows.

$${\underline{A}}_{cp \vert x} = \underline{A} + \sqrt{- 1} RotLeft ( \underline{A} , c / 2 ) . \qquad [ Formula 35 ]$$

Meanwhile, as RotLeft consumes a multiplication depth, the level of A_{cplx} may be smaller than the level of A by 1. Because of this, the multiplication depth of A^{τ}B may be increased by 1 when the level of A is smaller than the level of B. In this case, the input data matrix X is maintained in a state of not having been encrypted, and thus a calculation of the gradient

$${∇}_{W} {ℒ}_{CE} = \frac{1}{n} {( P - Y )}^{⊤} X$$

may be a depth 4 job. For alleviating this problem, an algorithm that consumes the depth of B but not A may ultimately be used.

First, RotLeft*(A, k) is defined as an incomplete left rotation of the matrix A by k. This is identical to a general left rotation Lrot(A, k), and does not consume a depth. However, the last k column in the result is rotated, and it is as follows with respect to A=(x_{i,j}).

$${RotLeft}^{*} ( A , k ) = [ \begin{matrix}{x}_{1 , k + 1} & … & {x}_{1 , c} & {x}_{2 , 1} & … & {x}_{2 , k} \\ {x}_{2 , k + 1} & … & {x}_{2 , c} & {x}_{3 , 1} & … & {x}_{3 , k} \\ ⋮ & ⋱ & ⋮ & ⋮ & ⋱ & ⋮ \\ {x}_{a , k + 1} & … & {x}_{a , c} & {x}_{1 , 1} & … & {x}_{1 , k}\end{matrix} ] \qquad [ Formula 36 ]$$

Then, PRotUp(B, k) is defined as a matrix wherein RotUp(−, 1) is applied only for the last k column. From the viewpoint of a matrix, the following may be acquired with respect to B=(yᵢⱼ).

$$PRotUp ( B , k ) = [ \begin{matrix}{y}_{1 , 2} & … & {y}_{1 , b - k} & {y}_{2 , b - k + 1} & … & {y}_{2 , b} \\ {y}_{2 , 1} & … & {y}_{2 , b - k} & {y}_{3 , b - k + 1} & … & {y}_{3 , b} \\ ⋮ & ⋱ & ⋮ & ⋮ & ⋱ & ⋮ \\ {y}_{a , 1} & … & {y}_{a , b - k} & {y}_{1 , b - k + 1} & … & {y}_{1 , b}\end{matrix} ] \qquad [ Formula 37 ]$$

This may be homomorphically calculated by using a single Cmult and an Lrot consuming a multiplication depth (in case B is clearly not encrypted, the job may not be deeded).

By using these new operations RotLeft* and PRotUp, A^{τ}B may be expressed as follows.

### Proposition 2

$${\underline{A}}^{⊤} B = X + Conj ( X ) \qquad [ Formula 38 ]$$

$$X = {\sum }_{0 \leq k < c / 2} SumRows ( Lrot ( {\underline{A}}_{cp \vert x} , k ) ⊙ PRotUp ( B , k ) ) ⊙ {M}_{cp \vert x}^{( - k , a )}$$

Here, [symbol] .

The learning results of HETAL-SDO and HETAL-FL through the method as above are as follows.

| | encrypted | | | | |
|---|---|---|---|---|---|
| | Running time | | | not encrypted | ACC loss |
| dataset | Total (s) | Time/ [symbol] (s) | ACC (a) | ACC (b) | ((b) − (a)) |
| MNIST | 2477.66 | 8.26 | 93.05% | 93.10% | 0.05% |
| CIFAR-10 | 1032.75 | 8.26 | 91.90% | 91.65% | −0.25% |
| Face Mask Detection | 499.78 | 1.78 | 95.46% | 95.46% | 0.00% |
| DermaMINIST | 1221.05 | 3.05 | 75.06% | 75.06% | 0.00% |
| SST-5 | 614.68 | 3.07 | 53.67% | 53.44% | −0.23% |
| SNIPS | 421.05 | 3.01 | 94.71% | 94.71% | 0.00% |
| MNIST (federated, C = 3) | 823.20 | 8.23 | 90.03% | 90.05% | 0.02% |
| CIFAR-10 (federated, C = 3) | 368.58 | 8.19 | 90.90% | 90.92% | 0.02% |
| Face Mask Detection (federated, C = 3) | 212.83 | 1.77 | 94.36% | 94.60% | 0.24% |
| DermaMINIST (federated, C = 3) | 454.79 | 3.03 | 73.32% | 73.67% | 0.35% |
| SST-5 (federated, C = 3) | 243.79 | 3.05 | 53.12% | 52.08% | −1.14% |
| SNIPS (federated, C = 3) | 149.44 | 2.99 | 94.29% | 94.43% | 0.14% |

[symbol]

indicates data missing or illegible when filed

Comparison with POSEIDON is as follows.

| | Training time (s) | | ACC | |
|---|---|---|---|---|
| dataset | [32] | HETAL-FL | [32] | HETAL-FL |
| MNIST (C = 10) | 5283 | 368 | 89.9% | 90.8% |
| CIFAR-10 (C = 50) | 665280 | 23 | 61.1% | 89.5% |

Comparison with a matrix multiplication algorithm is as follows.

| | AB [symbol] (A ∈ [symbol] ^{a×b}, B ∈ [symbol] ^{c×b}) | | | | | A [symbol] B (A ∈ [symbol] ^{a×c}, B ∈ [symbol] ^{c×b}) | | | | |
|---|---|---|---|---|---|---|---|---|---|---|
| (a, b, c) | [18] [symbol] | ColMajor | DiagABT | Speedup | | [18] [symbol] | ColMajor | DiagABT | Speedup | |
| (128, 128, 4) | 0.461 | 0.106 | 0.069 | 6.7 | 1.5 | 9.677 | 0.107 | 0.050 | 194 | 2.1 |
| (256, 256, 8) | 1.843 | 0.302 | 0.137 | 13.5 | 2.2 | 38.71 | 0.299 | 0.144 | 269 | 2.1 |
| (512, 769, 4) | 2.768 | 0.704 | 0.116 | 24.0 | 6.1 | 58.14 | 0.662 | 0.349 | 167 | 1.9 |
| (1024, 769, 8) | 5.537 | 2.831 | 0.326 | 17.0 | 8.7 | 116.3 | 2.647 | 1.394 | 83.4 | 1.9 |
| (2048, 769, 16) | 11.07 | 11.80 | 1.055 | 11.1 | 11.2 | 232.5 | 11.00 | 5.754 | 40.4 | 1.9 |

[symbol]

indicates data missing or illegible when filed

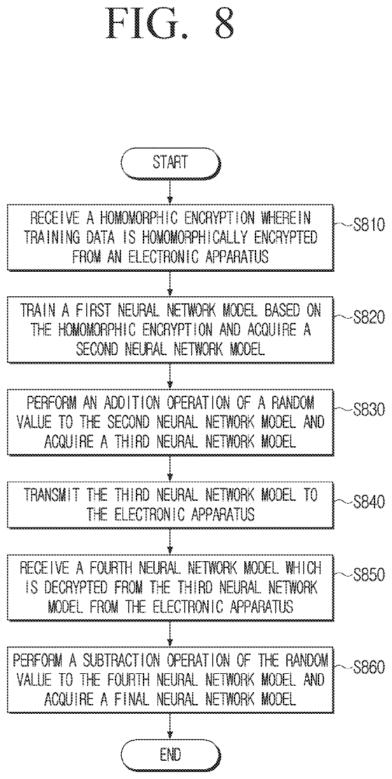

FIG. 8 is a flow chart for illustrating a control method of a server according to one or more embodiments of the disclosure.

First, a homomorphic encryption wherein training data is homomorphically encrypted is received from an electronic apparatus in operation S810. Then, a first neural network model is trained based on the homomorphic encryption and a second neural network model is acquired in operation S820. Then, an addition operation of a random value is performed to the second neural network model and a third neural network model is acquired in operation 5830. Then, the third neural network model is transmitted to the electronic apparatus in operation S840. Then, a fourth neural network model decrypted from the third neural network model is received from the electronic apparatus in operation S850. Then, a subtraction operation of the random value is performed to the fourth neural network model and a final neural network model is acquired in operation S860.

Also, in the operation S820 of acquiring the third neural network model, an addition operation of a plurality of random values may be performed to each of a plurality of weights included in the second neural network model and the third neural network model may be acquired, and in the operation S860 of acquiring the final neural network model, a subtraction operation of the plurality of random values may be performed to each of a plurality of weights included in the fourth neural network model and the final neural network model may be acquired.

In addition, the final neural network model may be a neural network model trained from the first neural network model based on the training data.

Also, in the operation S810 of receiving the homomorphic encryption, a plurality of homomorphic encryptions may be received from each of a plurality of electronic apparatuses, and in the operation S820 of acquiring the second neural network model, the first neural network model may be trained based on each of the plurality of homomorphic encryptions and a plurality of second neural network models may be acquired, and in the operation S830 of acquiring the third neural network model, an addition operation of the random value may be performed to each of the plurality of second neural network models and a plurality of third neural network models may be acquired, and in the operation S840 of transmitting, each of the plurality of third neural network models may be transmitted to the plurality of electronic apparatuses, and in the operation S850 of receiving the fourth neural network model, the plurality of fourth neural network models decrypted from each of the plurality of third neural network models may be received from each of the plurality of electronic apparatuses, and in the operation S860 of acquiring the final neural network model, a subtraction operation of the random value may be performed to each of the plurality of fourth neural network models and a plurality of fifth neural network models may be acquired, and weighted averaging of the plurality of fifth neural network models may be performed and a final neural network model may be acquired.

In addition, the control method may further include the step of receiving information on the number of training data of each of the plurality of electronic apparatuses from the plurality of electronic apparatuses, and in the operation S860 of acquiring the final neural network model, weighted averaging of the plurality of fifth neural network models may be performed based on the received information.

Also, in the operation S810 of receiving the homomorphic encryption, an operation key and the homomorphic encryption wherein the training data is homomorphically encrypted with an encryption key corresponding to the operation key may be received from the electronic apparatus, and in the operation S820 of acquiring the second neural network model, the first neural network model may be trained based on the homomorphic encryption and the operation key and the second neural network model may be acquired, and in the operation S830 of acquiring the third neural network model, an addition operation of the random value may be performed to the second neural network model and the third neural network model may be acquired, and in the operation S840 of transmitting, the third neural network model may be transmitted to the electronic apparatus, and in the operation S850 of receiving the fourth neural network model, the fourth neural network model decrypted from the third neural network model based on a decryption key corresponding to the operation key may be received from the electronic apparatus, and in the operation S860 of acquiring the final neural network model, a subtraction operation of the random value may be performed to the fourth neural network model and the final neural network model may be acquired.

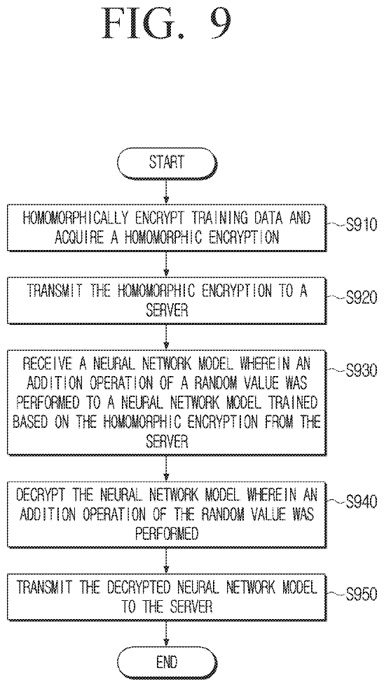

FIG. 9 is a flow chart for illustrating a control method of an electronic apparatus according to one or more embodiments of the disclosure.

Training data is homomorphically encrypted and a homomorphic encryption is acquired in operation S910. Then, the homomorphic encryption is transmitted to a server in operation S920. Then, a neural network model wherein an addition operation of a random value was performed to a neural network model trained based on the homomorphic encryption is received from the server in operation S930. Then, the neural network model wherein an addition operation of the random value was performed is decrypted in operation S940. Then, the decrypted neural network model is transmitted to the server in operation S950.

Also, in the operation S910 of acquiring, an encryption key, a decryption key, and an operation key may be acquired based on a homomorphic encryption algorithm, and the training data may be homomorphically encrypted based on the encryption key and the homomorphic encryption may be acquired, and in the operation S920 of transmitting the homomorphic encryption, the homomorphic encryption and the operation key may be transmitted to the server, and in the operation S930 of receiving, a neural network model wherein an addition operation of the random value was performed to a neural network model trained based on the homomorphic encryption and the operation key may be received from the server, and in the operation S940 of decrypting, the neural network model wherein an addition operation of the random value was performed may be decrypted based on the decryption key, and in the operation S950 of transmitting the decrypted neural network model, the decrypted neural network model may be transmitted to the server.

Meanwhile, methods according to the aforementioned various embodiments may be implemented in the form of a program code for performing each step, and stored in a recording medium or distributed. In this case, an apparatus on which the recording medium is mounted may perform the aforementioned operations such as encryption or encryption processing, etc.

Such a recording medium may be various types of computer-readable mediums such as a ROM, a RAM, a memory chip, a memory card, an external hard, a hard, a CD, a DVD, a magnetic disk, or a magnetic tape, etc.

So far, the disclosure has been described with reference to the accompanying drawings, but the scope of the disclosure is intended to be determined by the appended claims, and is not intended to be interpreted as being limited to the aforementioned embodiments and/or drawings. Also, it should be clearly understood that alterations, modifications, and amendments of the disclosure described in the claims that are obvious to a person skilled in the art are also included in the scope of the disclosure.

What is claimed is:

1. A server comprising:
a communication interface;
a memory configured to store at least one instruction; and
a processor configured to be connected with the communication interface and the memory, and control the server,
wherein the processor is configured to, by executing the at least one instruction,
receive, through the communication interface, a homomorphic encryption wherein training data is homomorphically encrypted from an electronic apparatus,
train a first neural network model stored in the memory based on the homomorphic encryption and acquire a second neural network model,
perform an addition operation of a random value to the second neural network model and acquire a third neural network model,
control the communication interface to transmit the third neural network model to the electronic apparatus,
receive, through the communication interface, a fourth neural network model which is decrypted from the third neural network model from the electronic apparatus, and
perform a subtraction operation of the random value to the fourth neural network model and acquire a final neural network model.

2. The server of claim 1,
wherein the processor is configured to:
perform an addition operation of a plurality of random values to each of a plurality of weights included in the second neural network model and acquire the third neural network model, and
perform a subtraction operation of the plurality of random values to each of a plurality of weights included in the fourth neural network model and acquire the final neural network model.

3. The server of claim 1,
wherein the final neural network model is a neural network model trained from the first neural network model based on the training data.

4. The server of claim 1,
wherein the processor is configured to:
receive, through the communication interface, a plurality of homomorphic encryptions from each of a plurality of electronic apparatuses,
train the first neural network model based on each of the plurality of homomorphic encryptions and acquire a plurality of second neural network models,
perform an addition operation of the random value to each of the plurality of second neural network models and acquire a plurality of third neural network models,
control the communication interface to transmit each of the plurality of third neural network models to the plurality of electronic apparatuses,
receive, through the communication interface, the plurality of fourth neural network models decrypted from each of the plurality of third neural network models from each of the plurality of electronic apparatuses,
perform a subtraction operation of the random value to each of the plurality of fourth neural network models and acquire a plurality of fifth neural network models, and
perform weighted averaging of the plurality of fifth neural network models and acquire a final neural network model.

5. The server of claim 4,
wherein the processor is configured to:
receive, through the communication interface, information on the number of training data of each of the plurality of electronic apparatuses from the plurality of electronic apparatuses, and
perform weighted averaging of the plurality of fifth neural network models based on the received information.

6. The server of claim 1,
wherein the processor is configured to:
receive, through the communication interface, an operation key and the homomorphic encryption wherein the training data is homomorphically encrypted with an encryption key corresponding to the operation key from the electronic apparatus,
train the first neural network model based on the homomorphic encryption and the operation key and acquire the second neural network model,
perform an addition operation of the random value to the second neural network model and acquire the third neural network model,
control the communication interface to transmit the third neural network model to the electronic apparatus,
receive, through the communication interface, the fourth neural network model decrypted from the third neural network model based on a decryption key corresponding to the operation key from the electronic apparatus, and
perform a subtraction operation of the random value to the fourth neural network model and acquire the final neural network model.

7. An electronic apparatus comprising:
a communication interface;
a memory configured to store at least one instruction; and
a processor configured to be connected with the communication interface and the memory, and control the electronic apparatus,
wherein the processor is configured to, by executing the at least one instruction,
homomorphically encrypt training data stored in the memory and acquire a homomorphic encryption,
control the communication interface to transmit the homomorphic encryption to a server,
receive, through the communication interface, a neural network model wherein an addition operation of a random value was performed to a neural network model trained based on the homomorphic encryption from the server,
decrypt the neural network model wherein an addition operation of the random value was performed, and
control the communication interface to transmit the decrypted neural network model to the server.

8. The electronic apparatus of claim 7,
wherein the processor is configured to:
acquire an encryption key, a decryption key, and an operation key based on a homomorphic encryption algorithm; and
homomorphically encrypt the training data based on the encryption key and acquire the homomorphic encryption,
control the communication interface to transmit the homomorphic encryption and the operation key to the server,
receive, through the communication interface, a neural network model wherein an addition operation of the random value was performed to a neural network model trained based on the homomorphic encryption and the operation key from the server,
decrypt the neural network model wherein an addition operation of the random value was performed based on the decryption key, and
control the communication interface to transmit the decrypted neural network model to the server.

9. A control method of a server, the method comprising:
receiving a homomorphic encryption wherein training data is homomorphically encrypted from an electronic apparatus;
training a first neural network model based on the homomorphic encryption and acquiring a second neural network model;
performing an addition operation of a random value to the second neural network model and acquiring a third neural network model;
transmitting the third neural network model to the electronic apparatus;
receiving a fourth neural network model which is decrypted from the third neural network model from the electronic apparatus; and
performing a subtraction operation of the random value to the fourth neural network model and acquiring a final neural network model.

10. The control method of claim 9,
wherein the acquiring the third neural network model comprises:
performing an addition operation of a plurality of random values to each of a plurality of weights included in the second neural network model and acquiring the third neural network model, and
the acquiring the final neural network model comprises:
performing a subtraction operation of the plurality of random values to each of a plurality of weights included in the fourth neural network model and acquiring the final neural network model.

11. The control method of claim 9,
wherein the final neural network model is a neural network model trained from the first neural network model based on the training data.

12. The control method of claim 9,
wherein the receiving the homomorphic encryption comprises:
receiving a plurality of homomorphic encryptions from each of a plurality of electronic apparatuses,
the acquiring the second neural network model comprises:
training the first neural network model based on each of the plurality of homomorphic encryptions and acquiring a plurality of second neural network models,
the acquiring the third neural network model comprises:
performing an addition operation of the random value to each of the plurality of second neural network models and acquiring a plurality of third neural network models,
the transmitting comprises:
transmitting each of the plurality of third neural network models to the plurality of electronic apparatuses,
the receiving the fourth neural network model comprises:
receiving the plurality of fourth neural network models decrypted from each of the plurality of third neural network models from each of the plurality of electronic apparatuses, and
the acquiring the final neural network model comprises:
performing a subtraction operation of the random value to each of the plurality of fourth neural network models and acquiring a plurality of fifth neural network models; and
performing weighted averaging of the plurality of fifth neural network models and acquiring a final neural network model.

13. The control method of claim 12, further comprising:
receiving information on the number of training data of each of the plurality of electronic apparatuses from the plurality of electronic apparatuses, and
the acquiring the final neural network model comprises:
performing weighted averaging of the plurality of fifth neural network models based on the received information.

14. The control method of claim 9,
wherein the receiving the homomorphic encryption comprises:
receiving an operation key and the homomorphic encryption wherein the training data is homomorphically encrypted with an encryption key corresponding to the operation key from the electronic apparatus,
the acquiring the second neural network model comprises:
training the first neural network model based on the homomorphic encryption and the operation key and acquiring the second neural network model,
the acquiring the third neural network model comprises:
performing an addition operation of the random value to the second neural network model and acquiring the third neural network model,
the transmitting comprises:
transmitting the third neural network model to the electronic apparatus,
the receiving the fourth neural network model comprises:
receiving the fourth neural network model decrypted from the third neural network model based on a decryption key corresponding to the operation key from the electronic apparatus, and
the acquiring the final neural network model comprises:
performing a subtraction operation of the random value to the fourth neural network model and acquiring the final neural network model.

15. A control method of an electronic device, the method comprising:
homomorphically encrypting training data and acquiring a homomorphic encryption;
transmitting the homomorphic encryption to a server;
receiving a neural network model wherein an addition operation of a random value was performed to a neural network model trained based on the homomorphic encryption from the server;
decrypting the neural network model wherein an addition operation of the random value was performed; and
transmitting the decrypted neural network model to the server.

16. The control method of claim 15,
wherein the acquiring comprises:
acquiring an encryption key, a decryption key, and an operation key based on a homomorphic encryption algorithm; and
homomorphically encrypt the training data based on the encryption key and acquiring the homomorphic encryption,
the transmitting the homomorphic encryption comprises:
transmitting the homomorphic encryption and the operation key to the server,
the receiving comprises:
receiving a neural network model wherein an addition operation of the random value was performed to a neural network model trained based on the homomorphic encryption and the operation key from the server,
the decrypting comprises:
decrypting the neural network model wherein an addition operation of the random value was performed based on the decryption key, and
the transmitting the decrypted neural network model comprises:
transmitting the decrypted neural network model to the server.
